(19) United States
(12) Patent Application Publication
(10) Pub. No.: US 2024/0426593 A1
(43) Pub. Date: Dec. 26, 2024

(54) INDUCTIVE ANGLE MEASURING DEVICE

(71) Applicant: DR. JOHANNES HEIDENHAIN GmbH, Traunreut (DE)

(72) Inventors: Martin HEUMANN, Traunstein (DE); Marc Oliver TIEMANN, Tettenhausen (DE); Oliver-Michael SELL, Traunreut (DE)

(21) Appl. No.: 18/752,983

(22) Filed: Jun. 25, 2024

(30) Foreign Application Priority Data
Jun. 26, 2023 (EP) 23181353.6

(51) Int. Cl. G01B 7/30; G01D 5/20

(52) U.S. Cl. CPC G01B 7/30; G01D 5/20

(57) ABSTRACT

An inductive angle measuring device includes a sensing element and a scale element rotatable relative to the sensing element. In a first receiving track, the sensing element includes a first receiving conductive path and a second receiving conductive path, by which a first signal can be generated and a second signal can be generated. The first and second signals have a first phase offset relative to each other. The sensing element further includes a fifth receiving conductive path, a sixth receiving conductive path, a seventh receiving conductive path, and an eighth receiving conductive path. The fifth and sixth receiving conductive paths are connected in series with each other, so that a first overall signal can be generated by the fifth and sixth receiving conductive paths. Furthermore, the seventh and eighth receiving conductive paths are also connected in series with each other, so that a second overall signal can be generated by the seventh and eighth receiving conductive paths. The first overall signal and the second overall signal have a second phase offset relative to each other.

### CROSS-REFERENCE TO RELATED APPLICATIONS

The present application claims priority to Application No. 23181353.6, filed in the European Patent Office on Jun. 26, 2023, which is expressly incorporated herein in its entirety by reference thereto.

### FIELD OF THE INVENTION

The present invention relates to an inductive angle measuring device.

### BACKGROUND INFORMATION

Inductive angle measuring devices are used to determine an angular position of machine parts that can be rotated relative to each other. In inductive position measuring devices, excitation tracks and receiving tracks, for example in the form of conductive paths, are often applied to a common printed circuit board which usually has multiple layers and is firmly connected, for example, to a stator of the position measuring device. Opposite this printed circuit board is a scale element on which graduation structures are applied and which is firmly connected to a movable part of the position measuring device. When a time-varying electrical excitation current is applied to the excitation tracks, signals dependent on the position are generated in the receiving tracks during the relative movement between the scale element and the sensing element. These signals are further processed in an evaluation electronic system.

An inductive angle measuring device is described in European Patent Document No. 1 715 298, which has an inner graduation track and an outer graduation track with different numbers of signal periods, so that an absolute determination of an angular position is possible in interaction with an associated sensing element.

### SUMMARY

Example embodiments of the present invention provide a comparatively accurately operating, compact, and inexpensively producible sensing element for an inductive angle measuring device.

According to example embodiments, an inductive angle measuring device includes a sensing element and a scale element, which can be rotated about an axis relative to the sensing element. The scale element has a first graduation track with first graduation structures that are arranged periodically along a circumferential direction around the axis, and a second graduation track with second graduation structures that are also arranged periodically along the circumferential direction. The sensing element has an excitation track and a first receiving track as well as a second receiving track. The first receiving track includes a first receiving conductive path and a second receiving conductive path. The first and second receiving conductive paths extend periodically along a first circular line with a first radius, e.g., with a constant first period length. The first and second receiving conductive paths are arranged offset to each other in the circumferential direction, so that a first signal can be generated by the first receiving conductive path and a second signal can be generated by the second receiving conductive path. The first signal and the second signal have a first phase offset to each other. The second receiving conductive path includes a fifth receiving conductive path, a sixth receiving conductive path, a seventh receiving conductive path, and an eighth receiving conductive path. The fifth, sixth, seventh, and eighth receiving conductive path respectively extend periodically along a second circular line with a second radius, e.g., with a constant second period length. The fifth, sixth, seventh, and eighth receiving conductive path extend along the circumferential direction and are respectively arranged offset to each other in the circumferential direction. The fifth and the sixth receiving conductive path are connected in series with each other, so that a first overall signal can be generated by the fifth and the sixth receiving conductive path. The seventh and the eighth receiving conductive path are also connected in series with each other, so that a second overall signal can be generated by the seventh and the eighth receiving conductive path. The first overall signal and the second overall signal have a second phase offset to each other.

In an angle measuring device, the sensing element is used to determine an angular position relative to a scale element, in which the scale element is arranged rotatably around an axis relative to the sensing element, so that the measuring direction represents the circumferential direction with respect to the axis.

For example, the second period length is greater than the first period length. The second receiving track thus provides comparatively lower resolution angular position information and is thus, e.g., referred to as a coarse track. Accordingly, the first receiving track can also be referred to as a fine track because it generates higher-resolution angular position information.

According to example embodiments, the first phase offset PH1 is a quarter of the first constant period length λ1 (i.e., PH1=¼·λ1), and the second phase offset PH2 may be a quarter of the second constant period length λ2 (i.e., PH2=¼·λ2). The period lengths λ1, λ2 may be specified in degrees or in radians and refer to a center angle around the axis A. The first phase offset PH1 and the second phase offset PH2 are thus related to the associated period length λ1, λ2 and may thus be expressed as a fraction of the corresponding period length λ1, λ2.

According to example embodiments, the first receiving track has a first number n1 of receiving conductive paths, and the second receiving track has a second number n2 of receiving conductive paths. The first number n1 is smaller than the second number n2 (i.e., n1<n2).

For example, the second number n2 is at least twice as large as the first number n1 (i.e., n2≥2·n1), e.g., exactly twice as large as the first number n1 (i.e., n2=2-n1).

For example, the first radius R1 of the first circular line and the second radius R2 of the second circular line are of different sizes. The second radius R2 may be smaller than the first radius R1 (R2<R1).

According to example embodiments, the sensing element includes a first excitation track and a second excitation track, and the first receiving track is surrounded radially on the outside by the first excitation track and is surrounded radially on the inside by the second excitation track. In contrast, the second receiving track is only surrounded on one side by the second excitation track.

For example, the sensing element is arranged such that the fifth and the sixth receiving conductive path extend periodically with a constant second period length λ2 and are also arranged offset from each other by an angular offset φ₂ along the circumferential direction, in which the angular offset φ2 is a maximum of 1/16 of the second period length (i.e., φ2≤ 1/16·λ2).

For example, the seventh and the eighth receiving conductive path extend periodically with the constant second period length λ2 and are arranged offset from each other along the circumferential direction by the angular offset φ2. The angular offset φ2 between the seventh and the eighth receiving conductive path is also, for example, a maximum of 1/16 of the second period length λ2, so that the following relationship is satisfied: φ2≤ 1/16·λ2.

According to example embodiments, the sensing element is arranged as a printed circuit board, in which the excitation track, the first receiving track, and the second receiving track are arranged in fewer than four electrically conductive layers, i.e., in fewer than four planes. The electrically conductive layers are structured such that the receiving conductive paths are formed therefrom. In addition, excitation tracks are generated by structuring the electrically conductive layers. For example, the sensing element may be arranged as a printed circuit board in which the excitation track, the first receiving track, and the second receiving track are arranged in exactly two electrically conductive layers.

For example, the sensing element is arranged so that the first receiving track and/or the second receiving track extend around the axis over the entire circumference. This means that at least one of the receiving conductive paths of the corresponding receiving track is always present over 360°, so that any radial line that starts from a center point located on the axis intersects at least one receiving conductive path. Thus, the first receiving track and/or the second receiving track has no gap over the entire circumference.

Further features and aspects of example embodiments of the present invention are described in more detail below with reference to the appended schematic Figures.

### BRIEF DESCRIPTION OF THE DRAWINGS

FIG. 1 is a perspective view of an angle measuring device that includes a sensing element and a scale element.

FIG. 2 is a top view of the scale element.

FIG. 3 is a top view of one side of the sensing element.

FIG. 4 is a top view of a part of the sensing element.

FIG. 5 is a top view of a part of the sensing element.

FIG. 6 illustrates receiving conductive paths of a first receiving track in an unwound representation.

FIG. 7 illustrates receiving conductive paths of a second receiving track in an unwound representation.

FIG. 8 illustrates signals from receiving conductive paths of the first receiving track.

FIG. 9 illustrates signals from receiving conductive paths of the second receiving track.

### DETAILED DESCRIPTION

As illustrated in FIG. 1, an angle measuring device includes a sensing element 1 adapted to detect an angular position of a scale element 2. The scale element 2 is arranged rotatably around an axis A relative to the sensing element 1. Such an angle measuring device can be used, for example, in a drive device, in which the scale element 2 is rotationally fixed to a drive shaft of a motor, for example.

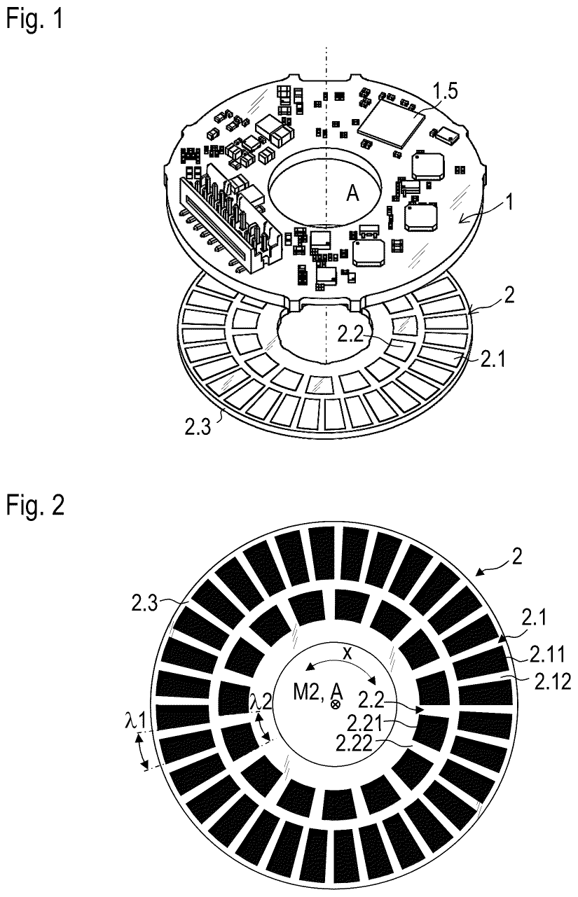

FIG. 2 is a top view of the scale element 2. The scale element 2 has an annular or circular shape. The scale element 2 includes, or consists of, a substrate 2.3, which may be produced from an epoxy resin and on which two graduation tracks 2.1, 2.2 are arranged. The graduation tracks 2.1, 2.2 are formed in the shape of a ring and are arranged on the substrate 2.3, concentrically with respect to the axis A or, for example, a scale center point M2 located on the axis A, with different radii, so that the first graduation track 2.1 extends along a first graduation circular line and the second graduation track 2.2 extends along a second graduation circular line. The graduation tracks 2.1, 2.2 include graduation structures respectively including, or consisting of, a periodic sequence of electrically conductive graduation regions 2.11, 2.21 and non-conductive graduation regions 2.12, 2.22 arranged alternately along the circumferential direction x, in which the electrically conductive graduation regions 2.11, 2.21 are respectively formed from a layer of electrically conductive material. In the illustrated example, t is applied to the substrate 2.3 as the material for the electrically conductive graduation regions 2.11, 2.21. In the non-conductive graduation regions 2.12, 2.22, on the other hand, the substrate 2.3 is not coated. In contrast to FIG. 1, the electrically conductive graduation regions 2.11, 2.21 are shown filled in black in FIG. 2.

With the arrangement with two graduation tracks 2.1, 2.2, the angular position of the scale element 2 can be determined absolutely. The outer first graduation track 2.1 of the scale element 2 has a greater number of respective graduation regions 2.11, 2.22 along the circumferential direction x, so that, through these, the greater resolution with respect to the measurement of the angular position can be achieved. For example, the first (outer) graduation track 2.1 has 32 respective graduation regions 2.11, 2.12 along the circumferential direction x. Accordingly, the first graduation track 2.1 has a first period length λ1 of 360°/32=11.25°.

The second (inner) graduation track 2.2, on the other hand, has only 15 respective graduation regions 2.21, 2.22, so that the second graduation track 2.2 has a second period length 22 of 360°/15=24°.

The period lengths λ1, λ2 are expressed, for example, in degrees and refer to a center angle around the axis A or, for example, around the scale center point M2.

The sensing element 1 is arranged as a printed circuit board, which has a plurality of layers, and electronic components 1.5, which are mounted on the sensing element 1.

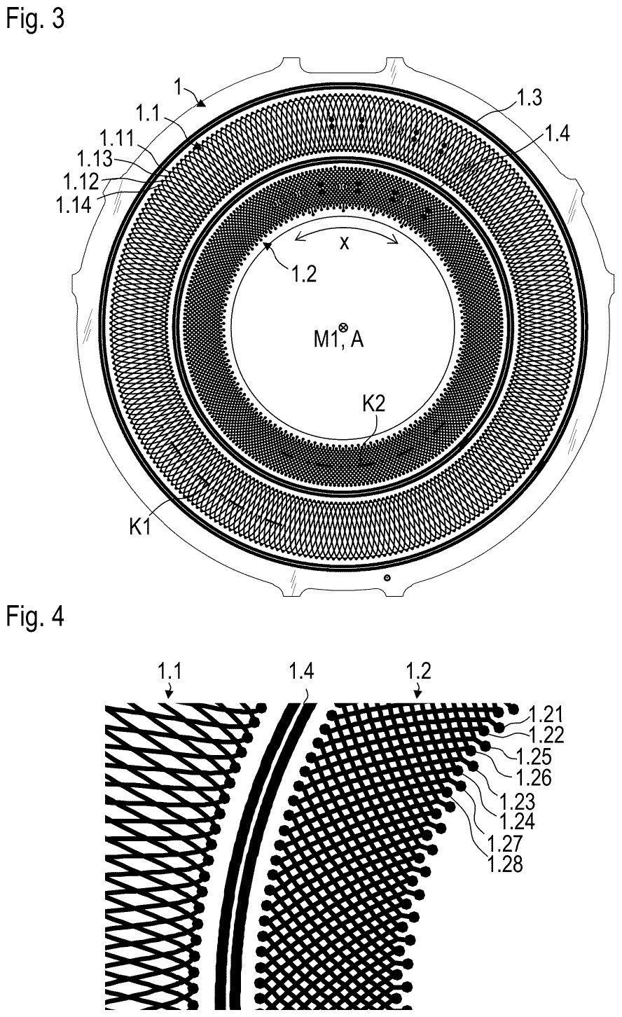

As also illustrated in FIG. 3, the sensing element 1 has the shape of a circular ring. For example, the electronic components 1.5 are only mounted on one side of the printed circuit board, e.g., on the side facing away from the scale element 2. Alternatively or additionally, it is also possible to fit both sides of the printed circuit board with electronic components 1.5.

As illustrated in FIG. 3, the sensing element 1 has a first receiving track 1.1 and a second receiving track 1.2 for determining the angle information. The receiving tracks 1.1, 1.2 each have a ring shape, in which, for both receiving tracks 1.1, 1.2, their center point M1 is located on the axis A. Accordingly, the receiving tracks 1.1, 1.2 are arranged concentrically in a first approximation with respect to the center point M1.

For example, the first receiving track 1.1 includes a first receiving conductive path 1.11, a second receiving conductive path 1.12, a third receiving conductive path 1.13, and a fourth receiving conductive path 1.14. Thus, the first receiving track 1.1 has a first number n1 (e.g., n1=4) of receiving conductive paths 1.11, 1.12, 1.13, 1.14.

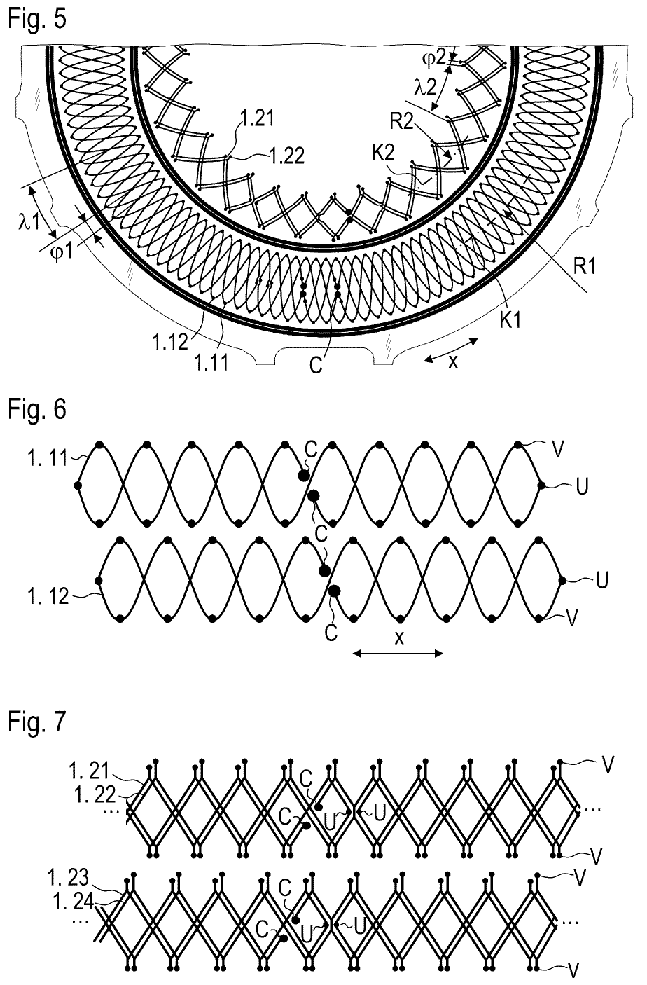

The receiving conductive paths 1.11, 1.12, 1.13, 1.14 of the first receiving track 1.1 are arranged offset to each other in the circumferential direction x, in which the receiving conductive paths 1.11, 1.12, 1.13, 1.14 extend along a first circular line K1, having a first radius R1 (see, FIG. 5). The receiving conductive paths 1.11, 1.12, 1.13, 1.14 of the first receiving track 1.1 have a spatially periodic curve which is substantially sine-shaped or sinusoidal. The receiving conductive paths 1.11, 1.12, 1.13, 1.14 of the first receiving track 1.1 also have the constant first period length λ1=11.25° along their curve, which period length can also be found in the first graduation track 2.1 (see, FIG. 5). The first period length λ1 thus extends over a center angle of 11.250 around the center point M1.

In FIG. 5, with regard to the first receiving track 1.1, only the first receiving conductive path 1.11 and the second receiving conductive path 1.12 are illustrated. The third receiving conductive path 1.13 and the fourth receiving conductive path 1.14 respectively arranged therebetween are not illustrated, for the sake of clarity. The following explanations are based on this representation of the first receiving conductive path 1.11 and the second receiving conductive path 1.12, in which the conditions also apply to the phase-shifted third and fourth receiving conductive paths 1.13, 1.14 respectively belonging to each other. For example, the first receiving conductive path 1.11 and the second receiving conductive path 1.12 are arranged offset from each other along the circumferential direction x by a first angular offset φ1, which corresponds to ¼ of the full first period length λ1. Consequently, within the first receiving track 1.1, immediately adjacent receiving conductive paths 1.11, 1.12, 1.13, 1.14 are arranged offset along the circumferential direction x by half of the first angular offset φ1.

The following relationship is satisfied: φ1=¼·λ1, so that the first angular offset φ1 is, for example, ¼·11.25°=2.81°.

As illustrated in FIG. 4, the second receiving conductive path 1.2 includes a fifth receiving conductive path 1.21, a sixth receiving conductive path 1.22, a seventh receiving conductive path 1.23, an eighth receiving conductive path 1.24, a ninth receiving conductive path 1.25, a tenth receiving conductive path 1.26, an eleventh receiving conductive path 1.27, and a twelfth receiving conductive path 1.28. Consequently, the second receiving track 1.2 has a second number n2 (e.g., n2=8) of receiving conductive paths 1.21 to 1.28. The receiving conductive paths 1.21 to 1.28 of the second receiving track 1.2 are also arranged offset relative to each other in the circumferential direction x. They they along a second circular line K2 (see, FIG. 5), which has a second radius R2. The receiving conductive paths 1.21 to 1.28 of the second receiving track 1.2 have a constant second period length λ2 along their curve, in which the curve deviates from an ideal sinusoidal shape. The receiving conductive paths 1.21 to 1.28 of the second receiving track 1.2 also have a periodic curve. For example, the second period length λ2 satisfies the following relationship: λ2=360°/15=24°.

Accordingly, for example, the second period length λ2 is greater than the first period length λ1 (e.g., λ2>λ1 The receiving conductive paths 1.21 to 1.28 of the second receiving track 1.2 extend along a second circular line K2, which has a second radius R2, and the second radius R2 is smaller than the first radius R1, so that the following relationship is satisfied: R2<R1.

Both circular lines K1, K2 have the same center point M1.

In addition, the first number n1 (e.g., n1=4) of receiving conductive paths 1.11, 1.12, 1.13, 1.14 of the first receiving track 1.1 is smaller than the second number n2 (e.g., n2=8) of receiving conductive paths 1.21 to 1.28 of the second receiving track 1.2, such that the following relationship is satisfied: n1<n2.

For example, the second number n2 is therefore also twice as large as the first number n1 (e.g., n2=2·n1).

In FIG. 5, for the second receiving track 1.2, only the fifth receiving conductive path 1.21 and the sixth receiving conductive path 1.22 are illustrated. The following explanations are based on this representation of the fifth receiving conductive path 1.21 and the sixth receiving conductive path 1.22, and the conditions also apply to the phase-shifted receiving conductive paths 1.23, 1.24, 1.25, 1.26, 1.27, 1.28 respectively belonging to each other. For example, within the second receiving track 1.2, adjacent receiving conductive paths 1.21 to 1.28 are arranged offset from each other along the circumferential direction x by a second angular offset φ2, which corresponds to 1/16 of the full second period length λ2 (i.e., (φ2=24°/16=1.5°). In case of the second receiving track 1.2, two adjacent receiving conductive paths 1.21 to 1.28 are connected in series with each other. For example, the fifth and the sixth receiving conductive path 1.21, 1.22 are connected in series with each other, as are the seventh and the eighth receiving conductive path 1.23, 1.24, the ninth and the tenth receiving conductive path 1.25, 1.26, and the eleventh and the twelfth receiving conductive path 1.27, 1.28.

Furthermore, the sensing element 1 includes a first excitation track 1.3 and a second excitation track 1.4. For example, the excitation tracks 1.3, 1.4 include several excitation lines, but can also be formed as only one excitation line. The first receiving track 1.1 extends radially inside the first excitation track 1.3 and radially outside the second excitation track 1.4. The second excitation track 1.4 also extends radially outside the second receiving track 1.2. Both the excitation tracks 1.3, 1.4 and the receiving tracks 1.1, 1.2 extend along the circumferential direction x.

The receiving conductive paths 1.11, 1.12, 1.13, 1.14 of the first receiving track 1.1, as well as the receiving conductive paths 1.21 to 1.28 of the second receiving track 1.2, are connected with vias V (see, FIGS. 6 and 7) in different layers of the printed circuit board, so that unwanted short circuits are avoided at crossing points. Although each of the receiving conductive paths 1.11 to 1.14, and 1.21 to 1.28, include, or consist of, many conducting pieces, each of which is distributed and connected together on two planes or layers, such a structure is collectively referred to as a receiving conductive path 1.11 to 1.14, 1.21 to 1.28.

FIG. 6 schematically illustrates the curve of the first and the second receiving conductive paths 1.11, 1.12, in which, for the sake of clarity, the first and the second receiving conductive paths 1.11, 1.12 are illustrated in an elongated manner. In addition, FIG. 6 illustrates the first and the second receiving conductive paths 1.11, 1.12, which are located on top of each other, shortened, and offset in relation to each other in order to illustrate the respective curves of the receiving conductive paths 1.11, 1.12 more clearly. Accordingly, the circumferential direction x, i.e., the measuring direction, is illustrated as linear. As described above, the first and second receiving conductive paths 1.11, 1.12 have a sine-shaped curve. The ends illustrated in FIG. 6 are electrically connected to each other at points U.

In FIG. 7, the fifth and the sixth receiving conductive path 1.21, 1.22 and the seventh and the eighth receiving conductive path 1.23, 1.24 are illustrated separately in a schematic linear arrangement. The simplified representation of FIG. 7 should be understood such that the left and right ends of the receiving conductive paths 1.21, 1.22, 1.23, 1.24 are connect together again, so that there is also a closed line, respectively, in which the fifth and the sixth receiving conductive path 1.21, 1.22 are connected in series with each other, as are the seventh and the eighth receiving conductive path 1.23, 1.24. Accordingly, the ends U of the receiving conductive path 1.21, 1.22, 1.23, 1.24 belonging together illustrated in FIG. 7 are electrically connected to each other at the points U. In FIG. 6, between the points U, the receiving conductive path 1.21, 1.22, 1.23, 1.24 extend in two planes one above the other, from top left to bottom right or from top right to bottom left. The receiving conductive paths 1.21, 1.22, 1.23, 1.24 have a largely straight curve in the form illustrated in FIG. 7, so that they each surround a diamond-shaped surface. This geometric arrangement makes it possible to achieve a relatively dense or close arrangement of the receiving conductive paths 1.21 to 1.28 on the substrate 1.3. If the receiving conductive paths 1.21 to 1.28 are bent according to the real arrangement, the receiving conductive paths 1.21 to 1.28 of the second receiving track 1.2 have a curved path with comparatively large radii between the reversal points. For reasons of space, the vias V are illustrated as having been moved outward, in which the radially inner vias V are arranged offset in a radial direction (see also, FIGS. 3 to 5).

In the assembled state, the sensing element 1 and the scale element 2 are opposite each other with an axial distance or an air gap, so that, when there is a relative rotation between the scale element 2 and the sensing element 1, a signal depending on the respective angular position can be generated in each of the receiving conductive paths 1.11 to 1.14, 1.21 to 1.28 by induction effects. A prerequisite for the formation of corresponding signals is that the excitation tracks 1.3, 1.4 generate a time-varying electromagnetic excitation field in the region of the respective sensed graduation structures. For example, the excitation tracks 1.3, 1.4 are arranged as a plurality of planar-parallel current-carrying individual conductive paths.

If the excitation tracks 1.3, 1.4 are supplied with current, a tubularly or cylindrically oriented electromagnetic field is formed around the excitation tracks 1.3, 1.4. The field lines of the resulting electromagnetic field extend around the excitation tracks 1.3, 1.4, and the direction of the field lines depends on the direction of the current in the excitation tracks 1.3, 1.4. Eddy currents are induced in the region of the electrically conductive graduation regions 2.11, 2.21, so that a modulation of the field is achieved that is dependent on the angular position. Accordingly, through the receiving tracks 1.1, 1.2, the relative angular position can be measured.

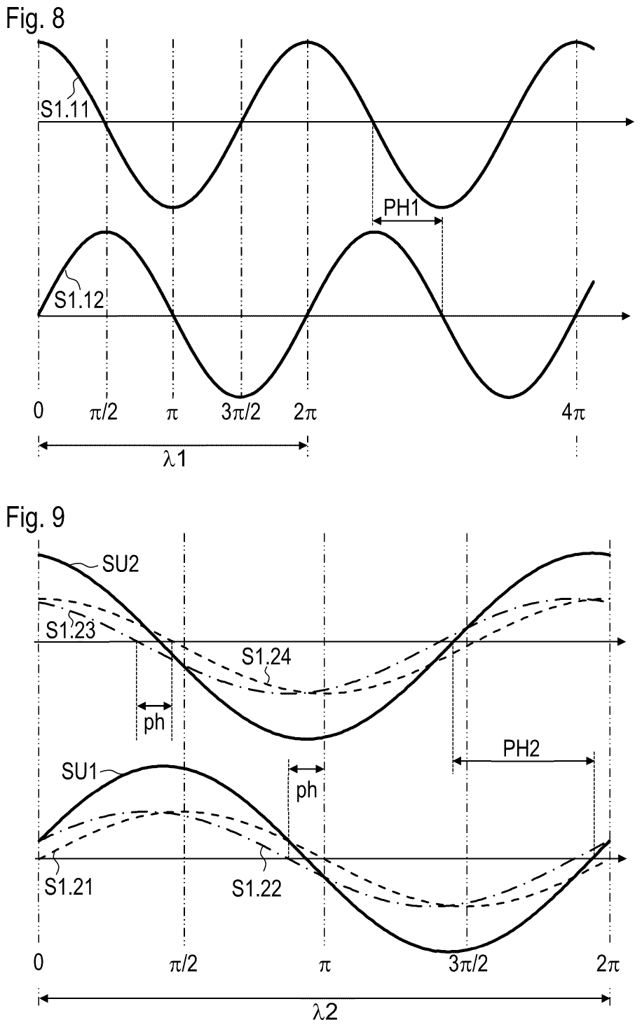

For example, first signals S1.11 generated or received by the first receiving conductive path 1.11 and second signals S1.12 generated or received by the second receiving conductive path 1.12 can be tapped at contact points C (see, for example, FIG. 6). The curve or the envelopes of the first signals S1.11 and the second signals S1.12 are illustrated in FIG. 8 as a function of the respective angular position between the sensing element 1 and the scale element 2. The first signal S1.11 and the second signal S1.12 have a first phase offset PH1 relative to each other, which is, for example, π/2, and the full period of the first signal S1.11 and the second signal S1.12 is 2π. The first receiving conductive path 1.11 and the second receiving conductive path 1.12 thus provide 0° and 90° signals.

The period of the first signal S1.11 and the second signal S1.12 results from the geometric arrangement of the first receiving conductive path 1.11 and the second receiving conductive path 1.12 in conjunction with the geometry of the first graduation track 2.1. As illustrated in FIG. 5, the first receiving conductive path 1.11 and the second receiving conductive path 1.12 have the geometric first period length λ1 and are arranged in the circumferential direction x with the angular offset φ1 (e.g., φ1=¼·λ1) to each other. Accordingly, the first signal S1.11 and the second signal S1.12 have a period corresponding to the first period length λ1. Furthermore, the amount of the first phase offset PH1 can also be expressed as ¼·λ1, i.e., PH1=¼·λ1.

The third receiving conductive path 1.13 and the fourth receiving conductive path 1.14 are arranged offset with respect to the first receiving conductive path 1.11 and the second receiving conductive path 1.12, so that the third receiving conductive path 1.13 provides third signals that are phase-shifted by π/4 with respect to the first signals S1.11 of the first receiving conductive path 1.11. Analogously, fourth signals of the fourth receiving conductive path 1.14 are phase-shifted by π/4 with respect to the second signals S1.12. The third and fourth signals are used for redundant position value acquisition, e.g., for safety-relevant applications.

As illustrated in FIG. 9, the fifth and sixth receiving conductive paths 1.21, 1.22 individually would generate a fifth signal S1.21 and a sixth signal S1.22. For example, the fifth signal S1.21 and the sixth signal S1.22 have a phase shift ph of π/8 (i.e., 22.5°). Since the fifth and the sixth receiving conductive path 1.21, 1.22 are connected in series with each other, they generate a first overall signal SU1.

Analogously, a seventh signal S1.23 and an eighth signal S1.24 would be generated individually by the seventh receiving conductive path 1.23 and the eighth receiving conductive path 1.24. The seventh and eighth signal S1.23, S1.24 have the same phase offset ph of π/8 to each other as the fifth signal S1.21 and the sixth signal S1.22. The seventh and eighth receiving conductive paths 1.23, 1.24 are also connected in series. As a result, a second overall signal SU2 is thus generated by the seventh and eighth receiving conductive paths 1.23, 1.24.

The amounts of the phase offset ph of π/8 and the second phase offset PH2 of π/2 should be understood in the context of the definition according to which a full period of the fifth, sixth, seventh, and eighth signals S1.21, S1.22, S1.23, S1.24 and the second overall signal SU2 is 2π.

The fifth, sixth, seventh, and eighth signals S1.21, S1.22, S1.23, S1.24 as well as the first overall signal SU1 and the second overall signal SU2 have an equal period with the second period length λ2. This results from the geometric configuration of the fifth receiving conductive path 1.21 and the sixth receiving conductive path 1.22 in conjunction with the geometry of the second graduation track 2.2. As illustrated in FIG. 5, these receiving conductive paths 1.21, 1.22 have the geometric second period length λ2 and are arranged in the circumferential direction x with the second angular offset φ2 (i.e., (φ2= 1/16·λ2) to each other. As a result, the fifth signal S1.21 and the sixth signal S1.22 have a period corresponding to the second period length λ2. In this respect, the magnitude of the phase shift ph between the fifth signal S1.21 and the sixth signal S1.22 or between the seventh signal S1.23 and the eighth signal S1.24 can also be specified as 1/16·λ2, i.e., ph= 1/16·λ2.

Furthermore, the first overall signal SU1 and the second overall signal SU2 have a second phase offset PH2 relative to each other, which is π/2, for example, in which the full period of the first overall signal SU1 and the second overall signal SU2 is 2n. Accordingly, the second phase offset PH2 is ¼·λ2, i.e., PH2=¼·λ2.

The first overall signal SU1 and the second overall signal SU2 can thus be used as 0° and 90° signals. The ninth to twelfth receiving conductive paths 1.25 to 1.28 can be used to form another pair of overall signals shifted by 90° to each other (e.g., 45° and 135° signals), so that redundant position value detection also takes place.

The sensing element 1 has an electronic circuit with the electronic components 1.5, which are electrically connected to each other. The electronic circuit can also include an ASIC component. The signals generated by the receiving tracks 1.1, 1.2 are further processed by some of the electronic components 1.5 that form an evaluation circuit. For example, in the configuration with the two graduation tracks 2.1, 2.2 and the two receiving tracks 1.1, 1.2, an absolute position can be calculated by the evaluation ASIC. This electronic circuit of the sensing element 1 operates not only as an evaluation element, but also as an excitation control element under whose control the excitation current is generated or produced, which passes through the excitation tracks 1.3, 1.4. Thus, the excitation tracks 1.3, 1.4 are supplied with current by one and the same excitation control element.

The first receiving track 1.1 is surrounded radially on the outside by the first excitation track 1.3 and at the same time surrounded radially on the inside by the second excitation track 1.4. In contrast, the second receiving track 1.2 is only surrounded on one side by the second excitation track 1.4. By applying the excitation field on one sided with respect to the second receiving track 1.2, an extremely space-saving configuration of the sensing element 1 can be achieved. Sufficiently large first signals S1.11 and second signals S1.12 can be generated by the configuration of the receiving tracks 1.1, 1.2, e.g., the second receiving track 1.2. In addition, the one-sided application of the excitation field affects the second receiving track 1.2, whose second period length 22 is greater than the first period length λ1 of the first receiving track 1.1, so that the one-sided application of the excitation field affects that (second) receiving track 1.2 that has the coarser resolution.

What is claimed is:

1. An inductive angle measuring device, comprising:
a sensing element including at least one excitation track, a first receiving track, and a second receiving track; and
a scale element rotatable relative to the sensing element and including a first graduation track having first graduation structures arranged periodically and a second graduation track with second graduation structures arranged periodically;
wherein the first track includes a first receiving conductive path and a second receiving conductive path, the first receiving conductive path and the second receiving conductive path extending periodically along a first circular line having a first radius, the first receiving conductive path and the second receiving conductive path being arranged offset relative to each other in a circumferential direction, the first receiving conductive path adapted to generate a first signal, the second receiving conductive path adapted to generate a second signal, the first signal and the second signal having a first phase offset relative to each other;
wherein the second receiving track includes a fifth receiving conductive path, a sixth receiving conductive path, a seventh receiving conductive path, and an eighth receiving conductive path, the fifth receiving conductive path, the sixth receiving conductive path, the seventh receiving conductive path, and the eighth receiving conductive path extending periodically along a second circular line having a second radius and being arranged offset to each other in the circumferential direction;
wherein the fifth receiving conductive path and the sixth receiving conductive path are connected in series with each other and are adapted to generate a first overall signal;
wherein the seventh receiving conductive path and the eighth receiving conductive path are connected in series with each other and are adapted to generate a second overall signal; and
wherein the first overall signal and the second overall signal have a second phase offset relative to each other.

2. The inductive angle measuring device according to claim 1, wherein the first receiving conductive path and the second receiving conductive path extend periodically with a constant first period length.

3. The inductive angle measuring device according to claim 1, wherein the fifth receiving conductive path, the sixth receiving conductive path, the seventh receiving conductive path, and the eighth receiving conductive path extend periodically with a constant second period length.

4. The inductive angle measuring device according to claim 2, wherein the fifth receiving conductive path, the sixth receiving conductive path, the seventh receiving conductive path, and the eighth receiving conductive path extend periodically with a constant second period length.

5. The inductive angle measuring device according to claim 4, wherein the second period length is greater than the first period length.

6. The inductive angle measuring device according to claim 1, wherein the first receiving conductive path and the second receiving conductive path extend periodically with a constant first period length, the first phase offset being one fourth of the first period length.

7. The inductive angle measuring device according to claim 1, wherein the fifth receiving conductive path, the sixth receiving conductive path, the seventh receiving conductive path, and the eighth receiving conductive path extend periodically with a constant second period length, the second phase offset being one fourth of the second period length.

8. The inductive angle measuring device according to claim 7, wherein the fifth receiving conductive path, the sixth receiving conductive path, the seventh receiving conductive path, and the eighth receiving conductive path extend periodically with a constant second period length, the second phase offset being one fourth of the second period length.

9. The inductive angle measuring device according to claim 1, wherein the first receiving track includes a first number of receiving conductive paths and the second receiving track includes a second number of receiving conductive paths, the first number being smaller than the second number.

10. The inductive angle measuring device according to claim 9, wherein the second number is at least twice as large as the first number.

11. The inductive angle measuring device according to claim 9, wherein the second number is twice as large as the first number.

12. The inductive angle measuring device according to claim 1, wherein the second radius is smaller than the first radius.

13. The inductive angle measuring device according to claim 1, wherein the at least one excitation track includes a first excitation track and a second excitation track, the first receiving track being surrounded radially on an outside by the first excitation track and radially on an inside by the second excitation track, the second receiving track being surrounded on one side only by the second excitation track.

14. The inductive angle measuring device according to claim 1, wherein the fifth receiving conductive path and the sixth receiving conductive path extend periodically with a constant second period length and are arranged offset from each other by an angular offset along the circumferential direction, the angular offset being a maximum of 1/16 of the second period length.

15. The inductive angle measuring device according to claim 1, wherein the seventh receiving conductive path and the eighth receiving conductive path extend periodically with a constant second period length and are arranged offset from each other by an angular offset along the circumferential direction, the angular offset being a maximum of 1/16 of the second period length.

16. The inductive angle measuring device according to claim 1, wherein the sensing element includes a printed circuit board, the excitation track, the first receiving track, and the second receiving track being arranged in less than four electrically conductive layers of the printed circuit board.

17. The inductive angle measuring device according to claim 1, wherein the first receiving track and/or the second receiving track extend over an entire circumference.

18. The inductive angle measuring device according to claim 1, wherein the sensing element includes a printed circuit board, the excitation track, the first receiving track, and the second receiving track being arranged in exactly two electrically conductive layers.

19. The inductive angle measuring device according to claim 1, wherein the first graduation structures and the second graduation structures include a layer of electrically conductive material arranged on a substrate.

20. The inductive angle measuring device according to claim 1, wherein the first receiving track is arranged as a fine track, and the second receiving track is arranged as a coarse track, the fine track adapted to generate higher-resolution angular position information than the coarse track.
